(19) United States
(12) Patent Application Publication
(10) Pub. No.: US 2008/0149592 A1
(43) Pub. Date: Jun. 26, 2008

(54) Plasma etch process for controlling line edge roughness

(76) Inventors: Rodolfo P. Belen, (US); Edward P. Hammond, (US); Brian K. Hatcher, (US); Dan Katz, (US); Theodoros Panagopoulos, (US); Alexander M. Paterson, (US); Valentin N. Todorow, (US)

Correspondence Address: LAW OFFICE OF ROBERT M. WALLACE, 2112 EASTMAN AVENUE, SUITE 102, VENTURA, CA, 93003, US

(21) Appl. No.: 11/986,545

(22) Filed: Nov. 20, 2007

Related U.S. Application Data
(60) Provisional application No. 60/873,087, filed on Dec. 5, 2006.

(51) Int. Cl. B44C 1/22

(52) U.S. Cl. 216/41

(57) ABSTRACT

Line edge smoothness in a hardmask etch process is improved by widening the chamber pressure process window by applying VHF power and increasing the chamber pressure to near the maximum value of the widened process window.

### CROSS-REFERENCE TO RELATED APPLICATIONS

This application claims the benefit of U.S. Provisional Application Ser. No. 60/873,087, filed Dec. 5, 2006.

### BACKGROUND

Line edge roughness is a critical aspect of wafer patterning by an etch process (see for example “Line-Edge roughness Characterization With a Three-Dimensional Atomic Force Microscope: Transfer During Gate Patterning Process”, by J. Thiault, et al., Journal of Vac. Sci. Technol. B, Vol. 23, No. 6, November/December 2005, pp. 3075-3079). Typically a layer of sacrificial material (e.g., an oxide hard mask) with a pattern already present is used as a mask for the etching of the layer below. Any imperfections or roughness created when the pattern is formed in the hard mask will be transferred to the underlying layer. Hence, when the hard mask is opened to form the transfer pattern, it is important that it be as clean as possible with maximum integrity to the original pattern.

When a chemical etch process (e.g. by exposure to a plasma without an applied bias power) is used to open the hard mask, the resulting etch rate can be slow and isotropic, and the existing roughness in the photoresist line above the hard mask is transferred to the hard mask. Also, the isotropic etch can exacerbate the high aspect ratio (thickness/width) of the photoresist line and make the line more susceptible to mechanical stresses that cause bending or waviness in the photoresist line.

With the decrease in device size in microelectronic integrated circuits, it is becoming more difficult to keep line edge roughness below the required threshold. Typically, the 3-sigma (3 times the variance) of the line edge of the hard mask must not exceed the line width (e.g., the gate width) of the structure to be etched. Currently, the industry is transitioning from 90 nm line widths to 45 nm line widths, and is preparing for a further transition to 32 nm line widths. The demand for line edge smoothness will therefore triple. There is therefore a great need to find a way to increase the line edge smoothness to various plasma etch processes.

### SUMMARY

An etch process using a hardmask to etch an underlayer is provided. The process of etching the hardmask includes supporting the substrate in a plasma reactor chamber, while introducing an etch process gas. VHF source power is applied, for example to a ceiling electrode of the chamber overlying the substrate. The process further includes setting pressure inside said plasma reactor chamber to a high pressure value above 30 mT, and maintaining said high pressure value until openings have been etched through said hardmask layer corresponding to the openings in said mask. The high pressure value may be as high as 90 mT. This increase in pressure increases the etch line edge smoothness in the hardmask layer. The process can further include coupling an HF or LF bias power to a wafer support electrode underlying the substrate.

### BRIEF DESCRIPTION OF THE DRAWINGS

So that the manner in which the exemplary embodiments of the present invention are attained and can be understood in detail, a more particular description of the invention, briefly summarized above, may be had by reference to the embodiments thereof which are illustrated in the appended drawings. It is to be appreciated that certain well known processes are not discussed herein in order to not obscure the invention.

FIG. 1 is a schematic view of a plasma reactor that can be employed in carrying out the method of the invention.

FIG. 2 is a graph depicting the effects of bias frequency on plasma density and ion energy.

FIG. 3 is a block flow diagram of a hardmask etch process in accordance with embodiments described herein.

FIGS. 4A, 4B and 4C are real images of the results of hardmask etch processes carried out using 60 MHz source power at chamber pressures of 30 mT, 60 mT and 90 mT, respectively.

FIGS. 5A and 5B are real images of the results of hardmask etch processes carried out using 27 MHz bias power on the wafer with zero source power and 500 Watts of VHF source power, respectively.

To facilitate understanding, identical reference numerals have been used, where possible, to designate identical elements that are common to the figures. It is contemplated that elements and features of one embodiment may be beneficially incorporated in other embodiments without further recitation. It is to be noted, however, that the appended drawings illustrate only exemplary embodiments of this invention and are therefore not to be considered limiting of its scope, for the invention may admit to other equally effective embodiments.

### DETAILED DESCRIPTION

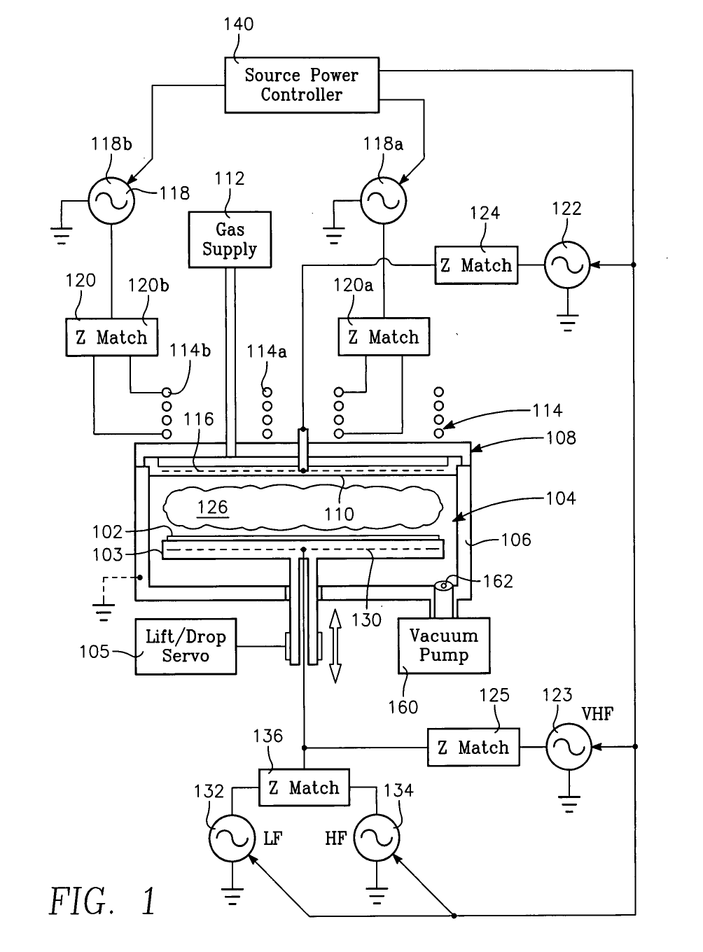

The reactor of FIG. 1 is for processing a workpiece 102, which may be a semiconductor wafer, held on a workpiece support 103, which may (optionally) be raised and lowered by a lift servo 105. The reactor consists of a chamber 104 bounded by a chamber sidewall 106 and a ceiling 108. The ceiling 108 may be a gas distribution showerhead 108 having small gas injection orifices 110 in its interior surface, the showerhead 108 receiving process gas from a process gas supply 112. The reactor includes both an inductively coupled RF plasma source power applicator 114 and a capacitively coupled RF plasma source power applicator, which may be either an electrode 116 within the ceiling 108 or an electrode 130 within the wafer support 103, or both. The inductively coupled RF plasma source power applicator 114 may be an inductive antenna or coil overlying the ceiling 108. In one embodiment, the gas distribution showerhead 108 may be formed of a dielectric material such as a ceramic. This may permit inductive coupling of RF power through the showerhead or ceiling 108. The function of a VHF capacitively coupled source power applicator may be performed by the ceiling electrode 116, or by the wafer support electrode 130. In one embodiment, RF source power may be capacitively coupled from both the ceiling 108 and the workpiece support 103. The ceiling electrode 116 may have multiple radial slots (not shown) to permit inductive coupling into the chamber 104 from the overhead coil antenna 114. An RF power source 118 provides high frequency (HF) power (e.g., within a range of about 10 MHz through 27 MHz) through an optional impedance match element 120 to the inductively coupled source power applicator 114. Another RF power generator 122 provides very high frequency (VHF) power (e.g., within a range of about 27 MHz through 200 MHz) through an optional impedance match element 124 to the ceiling electrode 116. As depicted in the drawing of FIG. 1, an optional RF power generator 123 provides VHF power to the wafer support electrode 130 through an impedance match 125.

As depicted in the drawing of FIG. 1, the inductive source power applicator 114 may consist of inner and outer coil antennas 114a, 114b, and the RF power source 118 and impedance match 120 consist of a first RF generator 118a coupled through a first impedance match 120a to the inner coil 114a, and a second RF generator 118b coupled through a second impedance match 120b to the outer coil 114b.

The efficiency of the capacitively coupled power source applicator (e.g., the ceiling electrode 116 and/or the wafer support electrode 130) in generating plasma ions increases as the VHF frequency increases, and the frequency range preferably lies in the VHF region for appreciable capacitive coupling to occur. As indicated symbolically in FIG. 1, RF power from the inductively coupled plasma source power applicator 114 and from the capacitively coupled plasma source power applicator (e.g., the ceiling electrode 116 or the wafer support electrode 130) is coupled to a bulk plasma 126 within the chamber 104 formed over the workpiece support 103. RF plasma bias power is capacitively coupled to the workpiece 102 from an RF bias power supply coupled to the workpiece support electrode 130. The RF bias power supply may include a low frequency (LF) RF power generator 132 and another RF power generator 134 that may be either a medium frequency (MF) or a high frequency (HF) RF power generator. An impedance match element 136 is coupled between the bias power generators 132, 134 and the workpiece support electrode 130. A vacuum pump 160 evacuates process gas from the chamber 104 through a valve 162 which can be used to regulate the evacuation rate. The evacuation rate through the valve 162 and the incoming gas flow rate through the gas distribution showerhead 108 determine the chamber pressure and the process gas residency time in the chamber.

The plasma ion density increases as the power applied by either the inductively coupled power applicator 114 or VHF capacitively coupled power applicator 116 (or 130) is increased. However, the plasma responds differently to the capacitively coupled VHF power and the inductively coupled HF power. The inductively coupled power promotes more dissociation of ions and radicals in the bulk plasma and a center-low radial ion density distribution. In contrast, the VHF capacitively coupled power promotes less dissociation and a center high radial ion distribution, and furthermore provides greater ion density as its VHF frequency is increased.

The inductively and capacitively coupled power applicators may be used in combination or separately, depending upon process requirements. In one embodiment, the inductively coupled RF power applicator 114 and the capacitively coupled VHF power applicator 116 couple power to the plasma simultaneously, while the LF and HF bias power generators simultaneously provide bias power to the wafer support electrode 130. The simultaneous operation of these sources enables independent adjustment of the most important plasma processing parameters, such as plasma ion density, plasma ion radial distribution (uniformity), dissociation or chemical species content of the plasma, sheath ion energy and ion energy distribution (width). For this purpose, a source power controller 140 regulates the source power generators 118, 122 independently of one another (e.g., to control their ratio of powers) in order to control bulk plasma ion density, radial distribution of plasma ion density and dissociation of radicals and ions in the plasma. The controller 140 is capable of independently controlling the output power level of each RF generator 118, 122. In addition, or alternatively, the controller 140 is capable of pulsing the RF output of either one or both of the RF generators 118, 122 and of independently controlling the duty cycle of each, or of controlling the frequency of the VHF generator 122 and, optionally, of the HF generator 118. In addition, the controller 140 controls the output power level of each of the bias power generators 132, 134 independently in order to control both the ion energy level and the width of the ion energy distribution.

When bias power from the bias power generator 134 is applied at a sufficiently high radio frequency (27-60 MHz), line edge roughness induced during hardmask etch can be greatly reduced. Another approach to improve line edge roughness is to pulse either the applied bias power from the RF bias power generator 132 or 134 or the plasma source power from the RF source power generator 118 or 122.

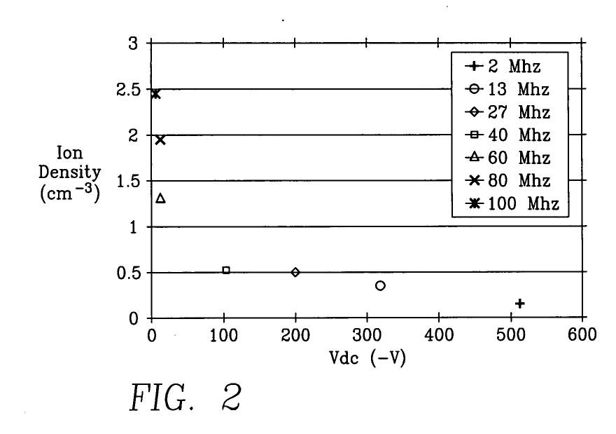

The roughness of the hard mask lines depends upon the etching chemistry as well as the energy of the ion bombardment. By adjusting the frequency of the bias power, tradeoffs can be made between the ion energy and plasma ion/etching radical density. For a given bias power level, at relatively low frequencies (2 MHz), the plasma density created is low but the ion energy is high; at higher frequencies (60 MHz), the plasma density is high but the ion energy is low (as shown in the graph of FIG. 2). With a lower frequency bias (e.g., from the RF generator 132 or 134), typically the plasma source power applicator 114 and/or 116 is used to generate plasma ions, and the ion energy is higher for a given bias power (compared to higher bias frequencies).

When some bias power is applied, the etch rate increases and becomes more anisotropic, and the ion bombardment provides some smoothing of the photoresist mask lines. However, as more bias power is applied, the ion energy increases and can begin to roughen the photoresist (and hard mask) line. An example was carried out involving three regimes for a mask opening process using HF (13.56 MHz) bias power. When the bias power is too low (20 W), the hard mask line is wavy. If the bias power is adequate (100 W), a relatively smooth line results, but the process window to achieve this result is extremely narrow, in that the bias power cannot vary from 100 W and the chamber pressure cannot vary (e.g., from about 30 mT). However, too much bias power (190 W) can roughen the line due to an overly energetic bombardment. Such a narrow process window is not always achievable or, even if briefly met, cannot be sustained reliably over an entire wafer etch process or a succession of wafer etch processes.

VHF power may be used in the bias by applying 60 MHz power to the workpiece support electrode 130 from the VHF generator 123. This results in a much smoother line after the hard mask open process. 60 MHz is a sufficiently high frequency for the bias power to act as a source of plasma on its own. In one embodiment, the inductively coupled source power applicator 114 is not required to generate plasma ions when using 60 MHz on the bias during the hard mask open process. Also, the 60 MHz bias power can provide sufficient ion energy so that the 13 MHz bias power may be turned off (by turning off the HF generator 134) and the line edge roughness is still acceptable. In one embodiment of the invention, the application of VHF power is used to enable the chamber pressure to be raised without proportionately worsening line edge roughness in the hardmask. In the prior art, such an increase in chamber pressure has been avoided to avoid worsening line edge roughness. Prior to the embodiments of the present invention, the chamber pressure was limited to well below 30 mT in such a process, typically closer to 4-10 mT in order to maintain line edge smoothness. Embodiments of the present invention enable the chamber pressure to be increased to 90 mT while still obtaining favorable line edge roughness results. This illustrates that the 60 MHz VHF bias can also provide a broader process window for the hard mask open process. In another embodiment of the present invention, the chamber pressure is increased in the upper limit to increase line edge smoothness in the etched hardmask layer. In one embodiment, the chamber pressure is maintained at 90 mT for an etching process and the line edge smoothness is increased. Therefore, embodiments of the present invention not only widen the process window, but also increase line edge smoothness.

HF bias power at 27 MHz (from the HF generator 134) used in the bias produces similar results to those obtained from bias power at 60 MHz, except that it provides a higher etch rate. However, if a low frequency such as 2 MHz (from the LF generator 132) is used in conjunction with the 27 MHz (from the HF generator 134), it can degrade the line edge roughness if excessive power is used. This is probably due to the higher energy ion bombardment which the low frequency exhibits.

In this aspect, we have made the surprising discovery that applying VHF power at 60 MHz to the pedestal or workpiece support electrode 130 as both the plasma source power and the plasma bias power provides a satisfactory etch rate at a chamber pressure of about 30 mT. The line edge smoothness improves and etch rate drops significantly as the chamber pressure is increased from 30 mT to 90 mT.

Applying 27 MHz to the wafer support electrode 130 as both the plasma source power and the plasma bias power not only provides a satisfactory etch rate at a chamber pressure of 30 mT, but the etch rate increases significantly as the chamber pressure is increased to 90 mT. This aspect therefore provides a much wider process window with regard to chamber pressure, enabling the pressure to be increased with no loss of etch rate, and with an actual increase in etch rate, by decreasing the frequency of the source/bias power applied to the cathode or pedestal. An even further increase in etch rate is obtained by applying a small amount of LF power to the pedestal in addition to the 60 MHz or 27 MHz, but the LF power level must be a fraction of the total power in order to avoid affecting the line edge roughness.

An alternative approach to improving the line edge roughness is to pulse either the bias power (from the generator 132, 134 or 123) or the plasma source power (from the generator 118 or 124). The source power may be either a VHF frequency applied to the overhead electrode 116 in the case of a capacitively coupled plasma or an HF frequency (e.g., 13.56 MHz) applied to the overhead coils 114 in the case of an inductively coupled plasma. Plasma pulsing can reduce the average sheath voltage, as with the VHF bias power. This is another way to control the energy of the ion bombardment.

Also, using the overhead VHF source power applicator or ceiling electrode 116 separately from the bias or wafer support electrode 130 can reduce the line edge roughness. For example, when 400 W at 27 MHz in the bias (i.e., at the wafer support electrode 130) is used to generate plasma and provide the ion bombardment energy, a reasonable line edge roughness is obtained, but when a low frequency (e.g., 60 W at 2 MHz) in the bias is added, the roughness is noticeably increased, particularly for a hardmask opening process carried out at 30 mTorr. However, when 500 W at 60 MHz is applied to the ceiling electrode 116 as the plasma source and 60 W at 2 MHz is used in the bias, the line edge roughness is reasonable and the etch rate is not depressed.

When 500 W at 60 MHz is applied to the ceiling electrode in conjunction with 400 W of 27 MHz in the bias, the line edge roughness is improved relative to the case with the 400 W 27 MHz bias only.

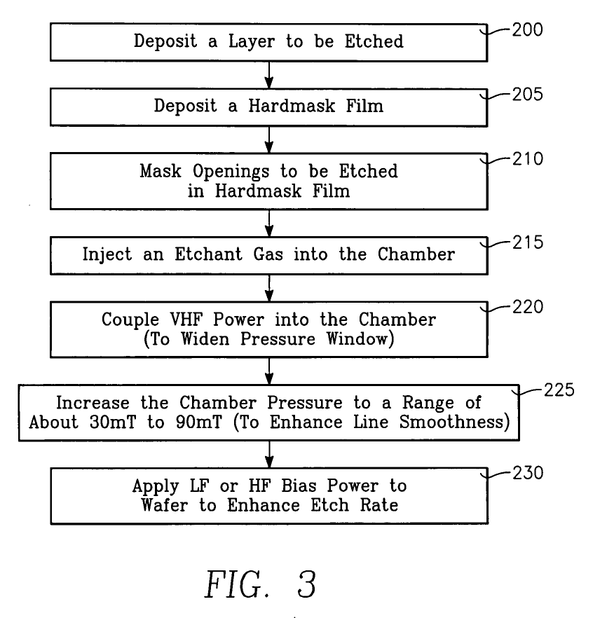

A process in accordance with above-described embodiments is illustrated in the block diagram of FIG. 3. First, a layer that is to be etched is deposited onto the semiconductor wafer or workpiece a (block 200 of FIG. 3). Then, a hardmask layer or film, such as silicon dioxide, is deposited on top of the layer that is to be etched (block 205). Openings that are to be etched in the lower layer are defined on the top surface of the hardmask layer by a photolithographic masking process (block 210). The wafer is inserted into the plasma reactor chamber, such as the chamber of FIG. 1, and an etch process gas is introduced into the chamber (block 215). The etch process gas may consist of a fluorocarbon gas, a fluorohydrocarbon gas and an inert gas, for example. A plasma is generated in the chamber by coupling VHF power into the chamber interior (block 220). The VHF power may be about 60 MHz, and may be coupled in to the chamber by either applying it to the ceiling electrode 116 from the RF generator 122 or to the workpiece support electrode 130 from the RF generator 123. The chamber pressure is raised to a high range above 30 mT and as high as 90 mT (block 225). Optionally, in addition to the VHF power applied in block 220, power at a lower frequency such as LF (2 MHz) or HF (13.56 MHz) may be applied as bias power to the wafer (block 230) by applying it to the workpiece support electrode 130.

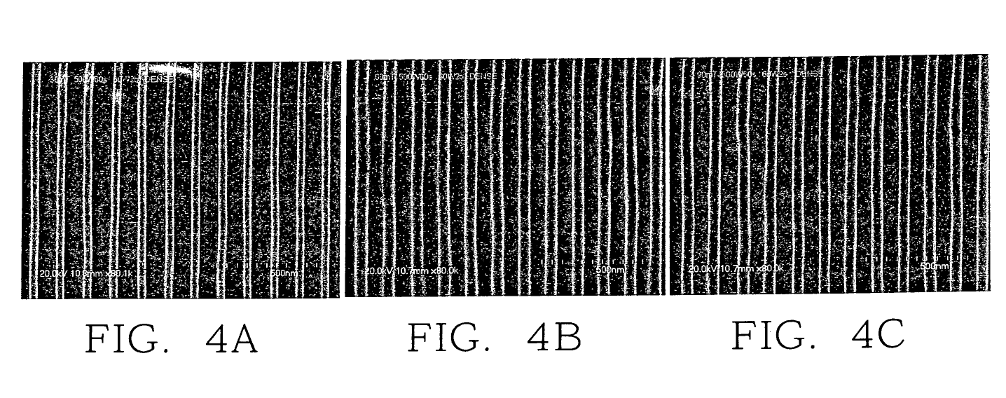

In a first working example, a hardmask film was etched in a chamber similar to that of FIG. 1 by injecting process gas through the showerhead 108 including CF₄ at a flow rate of 300 sccm and CHF₃ at a flow rate of 220 sccm. VHF source power at 60 MHz at a power level of 500 Watts was applied to the ceiling electrode 116. In addition, bias power of 2 MHz at a power level of 60 Watts was applied to the workpiece support electrode 130. Different wafers were subjected to this hardmask etch process at the following chamber pressures: 30 mT, 60 mT and 90 mT. This progression of increased chamber pressures yielded progressive improvement in etched line edge smoothness in the hardmask layer, a surprising result. This is seen in the real images of line edges in the hardmask layer in FIGS. 4A, 4B and 4C, corresponding respectively to the chamber pressure of 30 mT, 60 mT and 90 mT in the foregoing hardmask etch process.

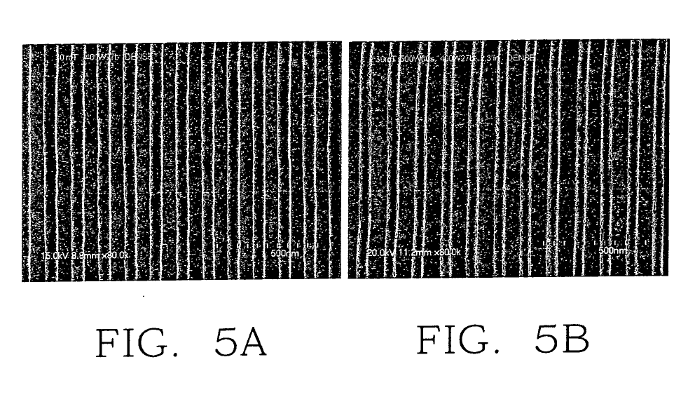

In a second working example, a hardmask film was etched in a chamber similar to that of FIG. 1 by injecting process gas through the showerhead 108 including CF₄ at a flow rate of 300 sccm and CHF₃ at a flow rate of 220 sccm. In addition, bias power of 27 MHz at a power level of 400 Watts was applied to the workpiece support electrode 130. Different wafers were subjected to this hardmask etch process with different levels of 60 MHz source power applied to the ceiling electrode 116. In a first version of this hardmask etch process, no VHF source power was applied to the ceiling electrode. The hardmask etch line roughness obtained in this first version is shown in the real image of FIG. 5A. A significant improvement in line edge smoothness was obtained in a second version of the process in which 500 Watts of 60 MHz source power was applied to the ceiling electrode 116. The improved line edge smoothness for this second version is shown in the real image of FIG. 5B.

While the foregoing working examples employed VHF power (e.g., 60 MHz) as source and or bias power, in other embodiments discussed previously in this specification, an HF frequency at the upper region of the HF band, e.g., 27 MHz, was employed as the combined bias and source power, and chamber pressure was increased (e.g., to between 30 and 90 mT) to improve the line edge smoothness in the etched hardmask layer.

In summary, embodiments of the present invention enable the chamber pressure range or window of a hardmask etch process to be increased nearly ten-fold while providing very smooth line edge definition. Embodiments of the present invention apply VHF power to the plasma, allowing chamber pressure to be increased from a nominal level of 10 mT to as high as 90 mT. We have discovered that such a pressure increase greatly improves line edge definition (by increasing line edge smoothness or decreasing line edge roughness). Etch rate is improved by supplementing the VHF power with RF bias power at an HF or LF frequency. If the VHF power is sufficiently high in frequency, addition of the lower frequency bias power does not degrade hardmask line edge smoothness. In the case of adding an LF frequency to the spectrum of applied power, the LF frequency is applied at a power level that is only a fraction of the total RF power coupled to the plasma to avoid degradation of line edge smoothness. In one embodiment, the VHF power is applied to the overhead electrode 116, while the added HF or LF power is applied to the workpiece support electrode 130. In another embodiment, the VHF power is applied to the wafer support (pedestal) electrode 130. In addition, improved line edge smoothness in the hardmask etch is obtained by pulsing the RF source power.

While the foregoing is directed to embodiments of the invention, other and further embodiments of the invention may be devised without departing from the basic scope thereof, and the scope thereof is determined by the claims that follow.

What is claimed is:

1. An etch process using a hardmask, comprising:
depositing a layer to be etched onto a substrate;
depositing a hardmask layer on a top surface of said layer to be etched;
depositing a mask layer on a top surface of said hardmask layer;
photolithographically defining openings in said mask layer;
while supporting said substrate in a plasma reactor chamber, introducing a process gas that is a precursor for species that etch the material of said hardmask;
applying VHF source power to a ceiling electrode of said chamber that overlies the substrate;
applying a lower frequency bias power to an electrode underlying the substrate;
setting pressure inside said plasma reactor chamber to a high pressure value above 30 mT, and maintaining said high pressure value until openings have been etched through said hardmask layer corresponding to the openings in said mask; and
etching said layer to be etched using said hardmask as an etch mask to form openings in said layer to be etched corresponding to openings in said hardmask.

2. The process of claim 1 wherein said high pressure value is about 60 mT.

3. The process of claim 1 wherein said high pressure value is about 90 mT.

4. The process of claim 1 wherein said VHF power is of a frequency of about 60 MHz.

5. The process of claim 2 wherein said lower frequency bias power is of a frequency of about 27 MHz.

6. The process of claim 1 further comprising pulsing said VHF source power.

7. An etch process using a hardmask, comprising:
depositing a layer to be etched onto a substrate;
depositing a hardmask layer on a top surface of said layer to be etched;
depositing a mask layer on a top surface of said hardmask layer;
photolithographically defining openings in said mask layer;
while supporting said substrate in a plasma reactor chamber, introducing a process gas that is a precursor for species that etch the material of said hardmask;
coupling VHF source power into said chamber;
setting pressure inside said plasma reactor chamber to a high pressure value above 30 mT, and maintaining said high pressure value until openings have been etched through said hardmask layer corresponding to the openings in said mask; and
etching said layer to be etched using said hardmask as an etch mask to form openings in said layer to be etched corresponding to openings in said hardmask.

8. The process of claim 7 wherein said high pressure value is about 60 mT.

9. The process of claim 7 wherein said high pressure value is about 90 mT.

10. The process of claim 1 wherein said VHF power is of a frequency of about 60 MHz.

11. The process of claim 7 wherein said VHF power is coupled into said chamber by an electrode in a workpiece support underlying said substrate.

12. An etch process using a hardmask, comprising:
depositing a layer to be etched onto a substrate;
depositing a hardmask layer on a top surface of said layer to be etched;
depositing a mask layer on a top surface of said hardmask layer;
photolithographically defining openings in said mask layer;
while supporting said substrate in a plasma reactor chamber, introducing a process gas that is a precursor for species that etch the material of said hardmask;
coupling RF power of an HF frequency into said chamber;
increasing the pressure inside said plasma reactor chamber to a pressure level above 30 mT, and maintaining said pressure level until openings have been etched through said hardmask layer corresponding to the openings in said mask; and
etching said layer to be etched using said hardmask as an etch mask to form openings in said layer to be etched corresponding to openings in said hardmask.

13. The process of claim 12 wherein said HF frequency is 27 MHz.

14. The process of claim 12 further comprising pulsing said RF power.

15. The process of claim 12 wherein said high pressure value is about 60 mT.

16. The process of claim 12 wherein said high pressure value is about 90 mT.

17. The process of claim 12 wherein said HF power is applied to an electrode underlying said substrate.

18. The process of claim 12 further comprising applying LF bias power to an electrode underlying said substrate.

19. The process of claim 18 wherein said LF bias power has a frequency of about 2 MHz.

20. The process of claim 12 further comprising pulsing said HF power.
